(19) United States
(12) Patent Application Publication
(10) Pub. No.: US 2005/0121290 A1
(43) Pub. Date: Jun. 9, 2005

(54) Medicine package conveying apparatus

(76) Inventors: Shoji Yuyama, Toyonaka-shi (JP); Nakaji Takeda, Toyonaka-shi (JP); Wataru Maeyama, Toyonaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/990,422

(22) Filed: Nov. 18, 2004

(30) Foreign Application Priority Data
Nov. 20, 2003 (JP) 2003-391113

(51) Int. Cl. B65G 47/26; B65D 85/00

(52) U.S. Cl. 198/459.2; 198/789

(57) ABSTRACT

A medicine package conveying apparatus is provided with a conveyor 7 and a roller member 9 to convey a medicine package 100 with a plurality of bags in which medicine is packaged. The roller member 9 is made of elastic material and comprises press portions 31 of cylindrical shape which rotate and press the both side edges of the medicine package 100 on the conveyor 7 and an escape portion 32 which is positioned between the press portions 31 and is smaller in a diameter than the press portions 31. Thus, the medicine package conveying apparatus can smoothly convey the medicine package.

### BACKGROUND OF THE INVENTION

The present invention relates to a medicine package conveying apparatus for conveying a medicine package in which medicine is packed by a medicine packing apparatus.

Conventionally, a belt-like medicine package in which medicine is packed by a medicine packing apparatus is conveyed by for example a conveyance apparatus described below from a lower position to a higher position easy to work.

There has been known a conveying apparatus in which a pair of flat belts which run on a plurality of rollers is positioned to form a conveyance passage for the medicine package with a predetermined distance and a tension unit is provided so as to adjust tension acting on the flat belts (for example, see Japanese patent No. 2538350).

There has been also known a package discharging, guiding and conveying apparatus in which a package guided into a insert hole by package guiding and traveling means is sandwiched between conveyance belts and conveyed as the conveyance belts are maintained in a strained state by a press roller provided on a tension arm (for example, see Japanese Laid-open Patent Publication No. H05-132008).

In the apparatuses described above, the medicine package is sandwiched between the belts having a constant gap and conveyed. When the medicine package contains a large amount of medicine and bulks up, causing problems of clogging, tearing of the medicine package and so on.

In the case that a capsule as medicine is contained in a package as shown in FIG. 10, the capsule may be packed in a state standing in a direction of thickness of the medicine package so that the capsule bulks up. This causes a problem that the medicine package cannot be smoothly conveyed.

### SUMMARY OF THE INVENTION

Thus, it is an object of the present invention to provide a medicine package conveying apparatus which can smoothly convey a medicine package.

In one aspect of the present invention, the medicine package conveying apparatus comprises:
a conveyor for conveying a medicine package with a plurality of bags in which medicine is packaged; and
a roller member made of elastic material, the roller member comprising press portions of cylindrical shape which rotate and press the both side edges of the medicine package on the conveyor and an escape portion which is positioned between the press portions and is smaller in a diameter than the press portions.

According to the above construction, driving of the conveyor allows the medicine package to be conveyed in a state that the medicine package is sandwiched between the conveyor and the press portions of the roller member. The press portions rotate in conjunction with the drive of the conveyor and also have elasticity, the medicine package can be conveyed in a stable condition without being damaged. Even if the medicine package bulges in a direction of the thickness of the medicine package as in the cases that a capsule contained in the medicine package is standing in the direction of the thickness of the medicine package and that powder contained in the medicine package is biased, the escape portions never cause that the medicine package is prevented from conveying.

Preferably, the escape portion is formed so as not to interfere with the medicine package to be conveyed. Thus, it is possible to surely eliminate clogging and so on of the medicine package and more smoothly convey the medicine package.

Preferably, the roller member is possible to pivot so that the roller member is released from the conveyor when the press portions are pushed up by a force of more than a standard value. Thus, any excessive load is not applied to the medicine package and therefore it is possible to surely preventing the medicine package from being damaged.

In another aspect of the present invention, the medicine package conveying apparatus comprises:
a conveyor for conveying a medicine package with a plurality of bags in which medicine is packaged; and
a roller member comprising a plurality of fin portions having an elasticity, the plurality of fin portions radially extending from a rotation shaft of the roller member so that at least one of the plurality of fin portions presses the medicine package on the conveyor.

According to the above construction, the medicine package is conveyed in a state that the medicine package is sandwiched between the conveyor and at least one of the fin portions. Even if the medicine package bulges in a direction of the thickness of the medicine package as in the cases that a capsule contained in the medicine package is standing in the direction of the thickness of the medicine package and that powder contained in the medicine package is biased, the fin portion is deformed so that the medicine package smoothly passes, which never causing that the medicine package is prevented from conveying.

Preferably, the roller member further comprises guide portions of cylindrical shape, the guide portions being positioned both sides of the rotation shaft and coming into contact with the conveyor to prevent the fin portion from deforming. Thus, it is possible to prevent the fin portions from deforming more than necessary and make it stable to convey the medicine package by means of the conveyor and the fin portions.

Preferably, the plurality of fin portions are positioned with such a pitch that when a capsule as the medicine is contained in the medicine package in a state standing in a direction of thickness of the medicine package, the capsule can be laid down. Thus, it is possible to convey the medicine package with the unsuitably contained state of the capsule dissolved.

AS the conveyor, any type of conveyors such as belt type, chain type, roller type, screw type and so on can be used. In a word, the conveyor may have a construction of band-like circulation unit for continuously conveying the medicine package.

As the press portion, any kinds of elastic material such as sponge, rubber and so on can be used. In this case, the whole of the roller member may be constituted of elastic material. The roller member may be constructed by fixing the press portions made of elastic material on the rotation shaft by means of adhesive or the like.

The press portions have a “cylindrical” shape, though the term of “cylindrical” means a shape having outer periphery (face or line) that is possible to sandwiching the medicine package between the outer periphery and the conveyor. Therefore, the “cylindrical” shape includes a disc or the like and may have the outer periphery partly cut out.

The shape of the escape portion is not limited and may include a solid cylinder as well as a hollow cylinder. In a word, the escape portion may have such a construction that the interference with the medicine package is reduced or eliminated even if the medicine package bulges in a direction of thickness of the medicine package. In the case that the escape portion partially interferes with the medicine package, it is also possible to make the interfering part of the escape portion elastic and adopt such a fin-like shape that the capsule can be forcedly laid down.

The roller member may be constructed so that the press portion can press the both side edges of the medicine package by its own weight.

The medicine package may have a sealed portion on at least one of side edge. In this case, the roller member may be constructed so that the press portion can press the sealed portion. Thus, the interference with the medicine contained in the medicine package can be eliminated.

The standard value of the force exerted on the press portion may be such a value that an excessive load applied to the medicine package does not lead to damage of the medicine package.

According to the present invention, as the medicine package is conveyed by the conveyor and the roller member comprising the press portions and the escape portion or the fin portions, it is possible to smoothly convey a medicine package without causing clogging or the like of the medicine package.

### BRIEF DESCRIPTION OF THE DRAWINGS

Further objects and advantages of the present invention will become clear from the following description taken in conjunction with the preferred embodiments thereof with reference to the accompanying drawings, in which:

FIG. 1 is a front view of a medicine packing apparatus according to one embodiment;

FIG. 2 is a perspective view of a medicine package conveying apparatus as shown in FIG. 1;

FIG. 3 is a partly broken perspective view of FIG. 2;

FIG. 4 is a partly broken perspective view viewed from a different direction from FIG. 3;

FIG. 5A is a front view of the medicine package conveying apparatus of FIG. 2, and FIG. 5B is a front view of the roller member showing a pivoted state;

FIG. 6 is a perspective view of a roller member used in the medicine package conveying apparatus of FIG. 2;

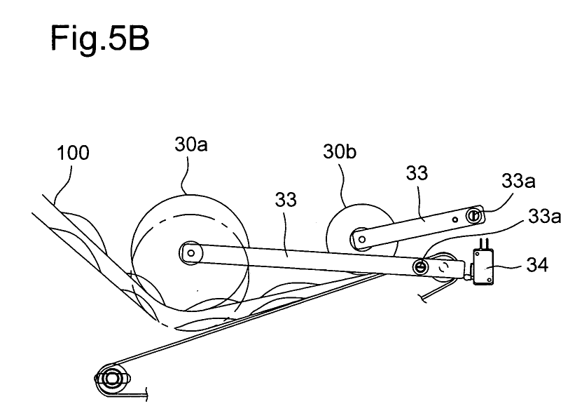

FIG. 7 is a perspective view of a medicine package conveying apparatus according to an another embodiment;

FIG. 8 is a perspective view of a roller member used in the medicine package conveying apparatus of FIG. 7;

FIG. 9A is a front view of a medicine package, FIG. 9B is a side view of FIG. 9A; and

FIG. 10 is a perspective view of an another example of medicine package.

### DETAILED DESCRIPTION OF THE PREFERRED EMBODIMENTS

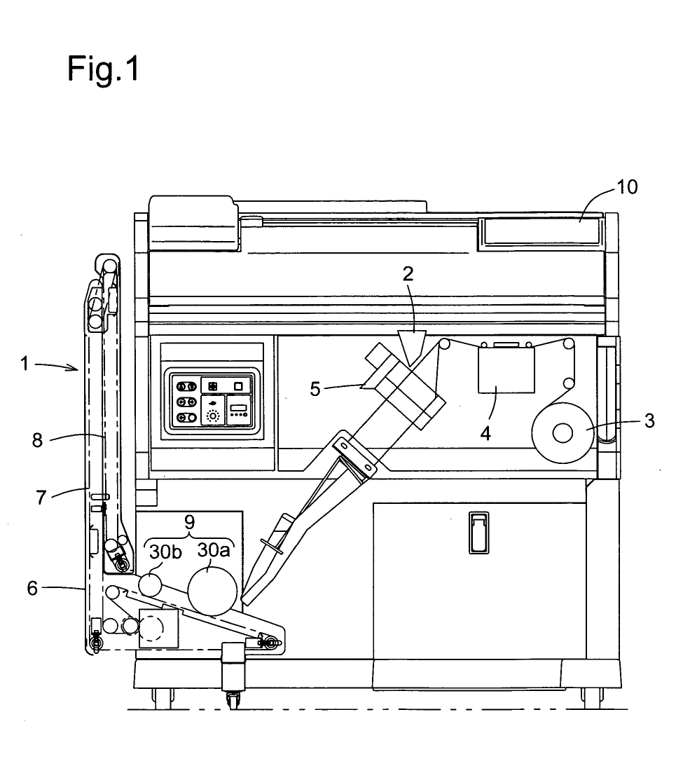

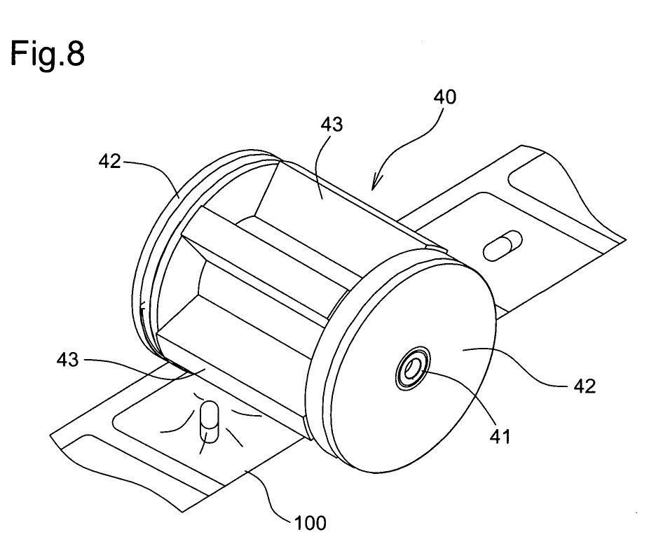

FIG. 1 shows a medicine packing apparatus provided with a medicine package conveying apparatus 1 according to one embodiment of the present invention. In the medicine packing apparatus, medicine (powder, tablet and so on) fed from an R disc or tablet feeders not shown are discharged through a hopper 2. Under the hopper 2, a belt-like packing sheet rewound from a roll 3 is fed in a condition folded into two after medicine name and usage and so on are printed by a printer 4. The packing sheet is sealed by means of a sealing unit 5 every time when a dose of medicine is contained in the packing sheet. Thus, as shown in FIG. 9, a medicine package 100 with a plurality of bags connected like a belt is formed.

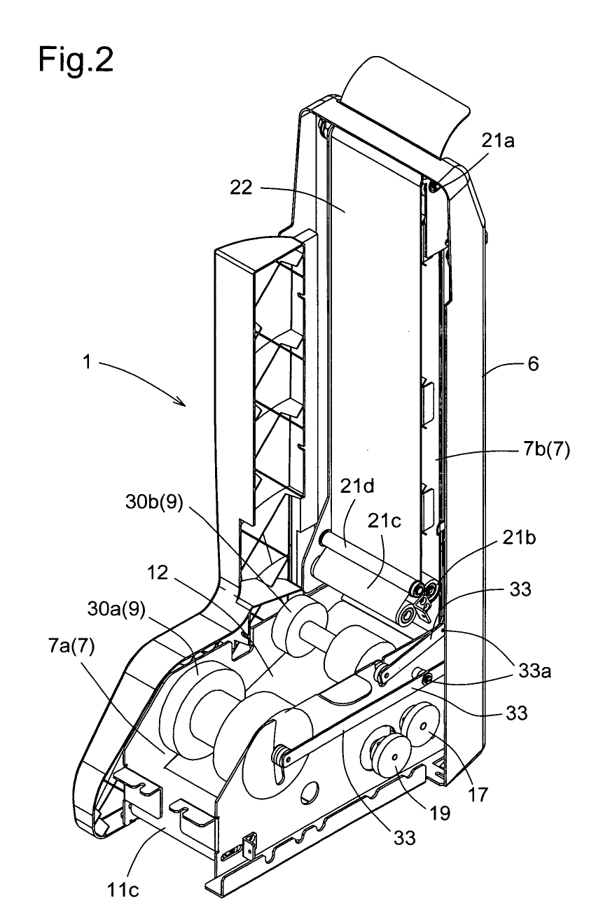

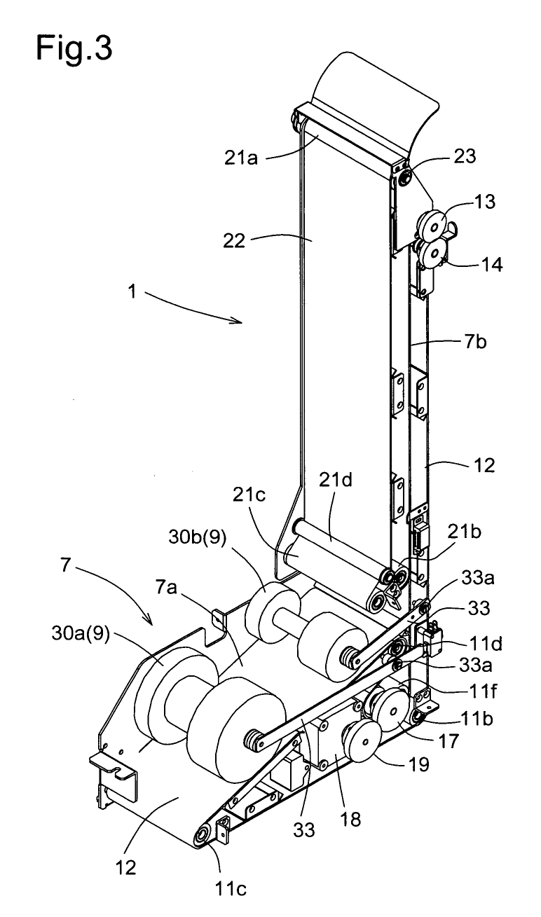

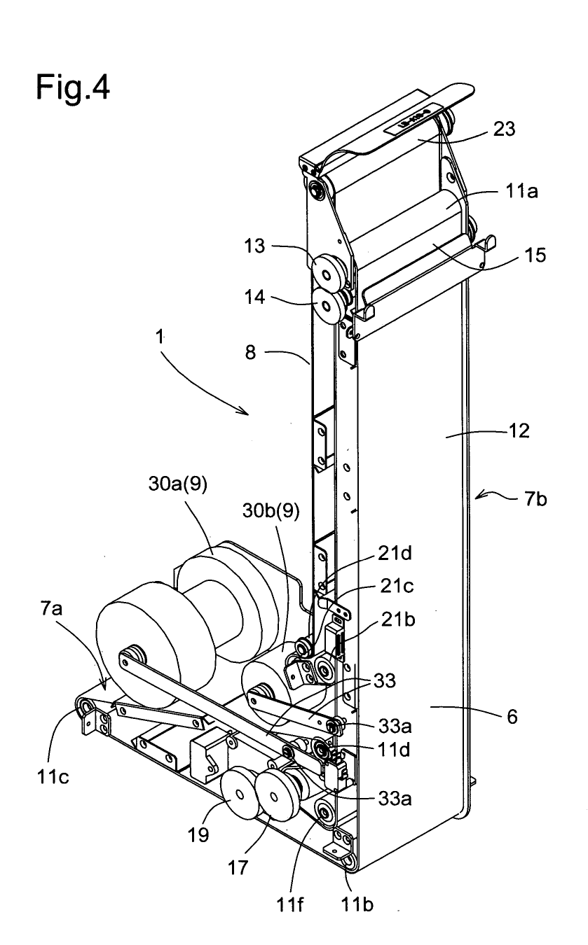

The medicine package conveying apparatus 1, as shown in FIGS. 2 to 5A, comprises a substantially L shaped frame 6, which is provided with a first belt conveyor 7, a second belt conveyor 8, a roller member 9 and so on. Conveyance of the medicine package 100 is controlled by a control unit 10.

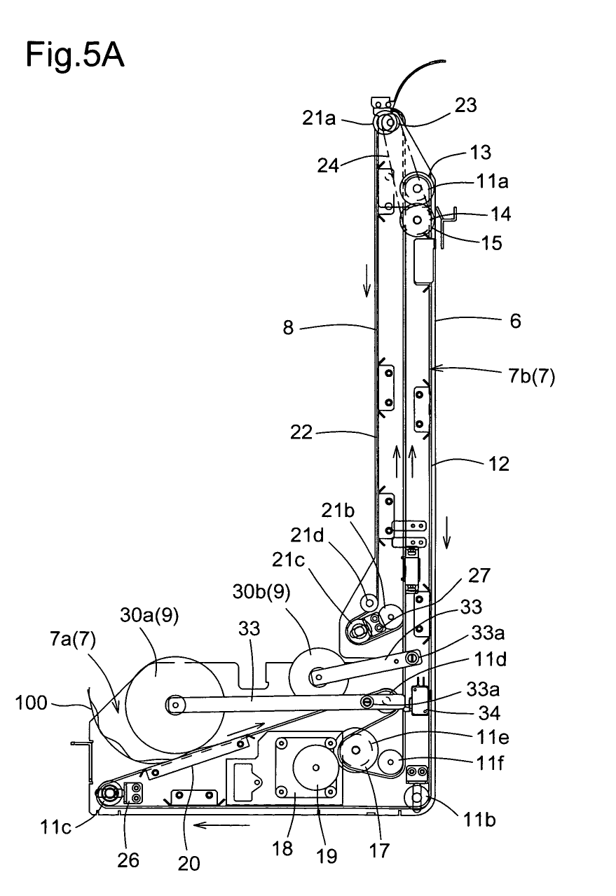

The first belt conveyor 7, as shown in FIG. 5A, comprises a flat belt 12 which runs on a plurality of rollers 11a, 11b, 11c, 11d, 11e and 11f. The first belt conveyor 7 is constituted by a horizontal conveying portion 7a and a vertical conveying portion 7b. The roller 11a positioned at the upper portion of the frame 6a is provided with a gear 13. The gear 13 engages with a gear 14 to which a pulley 15 is fixed. The roller 11e is provided with a gear 17 which engages with a gear 19 fixed on the rotation shaft of a motor 18. Thus, drive of the motor 18 causes the roller lie to rotate via the gears 19, 17, allowing the flat belt 12 to move in a direction of arrow. The horizontal conveying portion 7a has a portion positioned upper side of the flat belt 12 which is gradually inclined toward the vertical conveying portion 7b and a lower surface which is guided by a guide plate 20. The roller 11c is provided with a tension adjusting portion 26 which is possible to move the roller 11c in a horizontal direction to adjust a tension acted on the flat belt 12.

The second belt conveyor 8, like the first belt conveyor 7, comprises a flat belt 22 which runs on a plurality of rollers 21a, 21b, 21c and 21d. The second belt conveyor 8 is pibotably mounted on the frame 6 around the roller 21a so that the second belt conveyor 8 can contact with and depart from the first belt conveyor 7. To the roller 21a is fixed a pulley 23. A drive power of the motor 18 is transmitted via a belt 24 supported between the pulley 23 and the pulley 15 of the first belt conveyor 7. This allows the second belt conveyor 8 to move in synchronization with the first belt conveyor 7, causing the opposite flat belts 12, 22 to move from downward to upward together. The pivot position of the second belt conveyor 8 is detected by means of a pivot position detecting sensor (not shown) comprising a beam sensor and so on. In this embodiment, when the second belt conveyor 8 pivots by more than a constant angle from a vertical position, a detection signal of the pivot position detecting sensor is switched from ON to OFF. The roller 21c is provided with a tension adjusting portion 27 similar to the first belt conveyor 7.

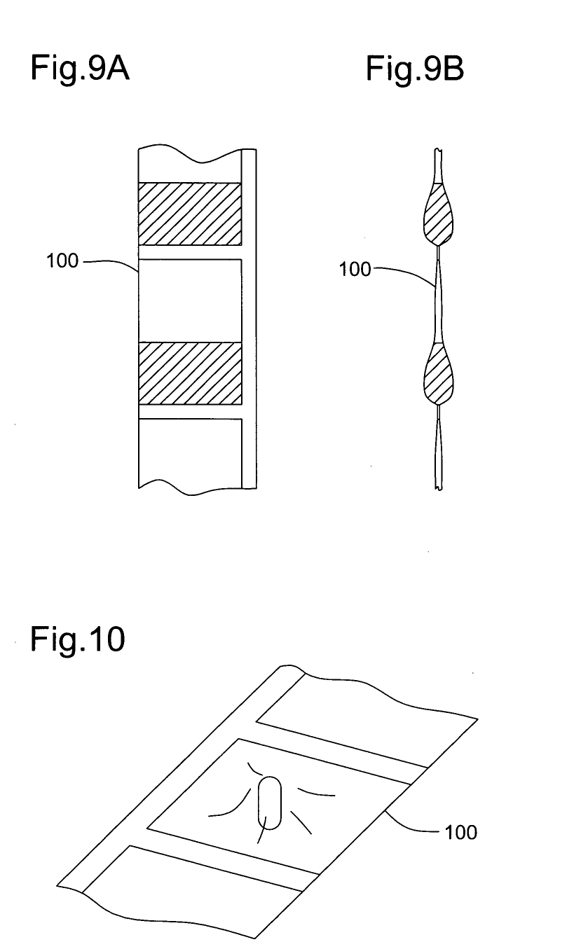

The roller member 9 comprises a first roller 30 and a second roller 30b. Both rollers 30a, 30b are made of elastic material, for example sponge and formed so that the external diameter is small except both end portions. The large diameter portions of both ends constitute press portions 31 while the central narrow portion of small diameter constitutes an escape portion 32. Each roller 30a, 30b is rotatably attached on one end of the arm 33. Other end of the arm 33 is supported on the frame 6 rotatably around a support shaft 33a. Thus, the roller member 9 presses the press portions 31 toward the first belt conveyor 7 by it's own weight so that the medicine package 100 is sandwiched between the press portions 31 and the flat belt 12. When the first belt conveyor 7 is driven, the roller member 9 rotates as the flat belt 12 moves, making the conveying state of the medicine package 100 stable. If a capsule is contained in the medicine package 100 in a standing state (FIG. 10) or a position where powder is contained in the medicine package 100 is biased, the thickness of the medicine package 100 becomes larger than expected. However, the thick portion of the medicine package 100 is positioned at the escape portion 32 of the roller member 9, eliminating interference with the roller member 9. In the event that clogging of the medicine package 100 is caused, if a force of more than standard value is exerted on the roller member 9, the roller member 9 moves around the support shaft 33a via the arm 33, which does not apply an excessive load to the medicine package 100. A pivoting position of the arm 33, i.e. each roller 30a, 30b is detected by means of the pivot position detecting sensor 34 comprising a beam sensor and so on. In this embodiment, when the arm 33 of the roller member 9 pivots by more than a constant angle from a horizontal position, a detection signal of the pivot position detecting sensor 34 is switched from ON to OFF. The detection signal is utilized for a drive control of the first belt conveyor 7.

The control unit 10 controls energization to the motor 18 based on the detection signal of the pivot position detecting sensor.

Hereinafter, operation of the medicine package conveying apparatus 1 will be described.

After a medicine is packed by one dose in accordance with a prescription data, a medicine package 100 is discharged to the medicine package conveying apparatus 1. The discharged medicine package 100 meets the horizontal conveying portion 7a of the first belt conveyor 7 and is conveyed in an approximately horizontal direction, i.e. in an obliquely upward direction for detail in a state that the medicine package 100 is sandwiched between the flat belt 12 and the first roller member 30a followed by the second roller member 30b as the flat belt 12 driven by the motor 18 moves. Then the medicine package 100 is introduced between the first belt conveyor 7 and the second belt conveyor 8 where the conveying direction is converted to upward, and then discharged from the upper end of the conveyors 7, 8. During this, the medicine package 100 moves in a space surrounded by the frame 6 and the both belt conveyors 7, 8, preventing adhesion of dust and so on.

By the way, as the size and quantity of the medicine contained in the medicine package 100 are varied, the bulge state of each medicine package 100 is different. When the medicine package 100 is conveyed in a vertical direction by the medicine package conveying apparatus 1, the medicine contained in the medicine package 100 is one-sided downward as shown in FIG. 9(b), enlarging the partial bulk of the medicine package 100. In the case that the medicine is a capsule, if the capsule is contained in a state that the capsule is standing in a direction of thickness of the medicine package 100 as shown in FIG. 10, the bulk of the central portion of the medicine package 100 becomes large. In this case, according to the roller member 9, the bulk portion of the medicine package 100 is positioned at the escape portion 32, eliminating interference with the roller member 9. Especially, even in the medicine package 100 comprising only two dose packages or the medicine package 100 having a long length, there is a tendency that the medicine package 100 can not be conveyed due to clogging and so on when the front end thereof passes through. However, according to the above construction, the medicine package 100 can be smoothly conveyed. In the event that clogging of the medicine package 100 is caused, the roller members 9 pivot around the support shafts 33a via the arms 33, eliminating interference with the roller member 9. Therefore, any excessive load is not applied to the medicine package 100, preventing the medicine package 100 from tearing.

In addition, the speed of the medicine package 100 fed to the medicine package conveying apparatus 1 varies based on the difference of kind or quantity of the medicine to be prescribed. On the other hand, the speed of the medicine package 100 conveyed by the medicine package conveying apparatus 1 is constant. Therefore, when the feed speed of the medicine package 100 is smaller than the conveying speed by the medicine package conveying apparatus 1, a tension force is exerted on the medicine package 100. In this case, when the roller member 9 is pivoted as shown in FIG. 5B and the pivot position is detected by the pivot position detecting sensor 34 (an OFF signal is outputted), the motor 18 is forcedly stopped. Thus, the tension force exerted on the medicine package 100 is relieved, preventing the medicine package 100 from leading to damage. Moreover, the pivot position detecting sensor 34 outputs an OFF signal only when the roller members 9 are over-pivoted. Thus, even if the output signal becomes OFF state due to failure, the motor 18 is stopped, preventing malfunction.

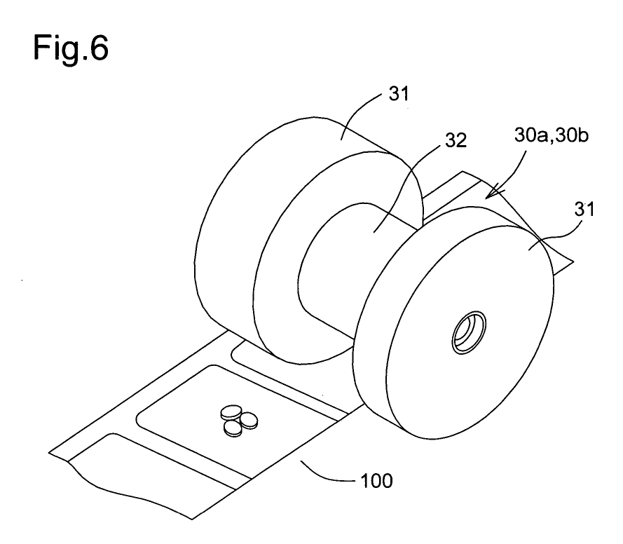

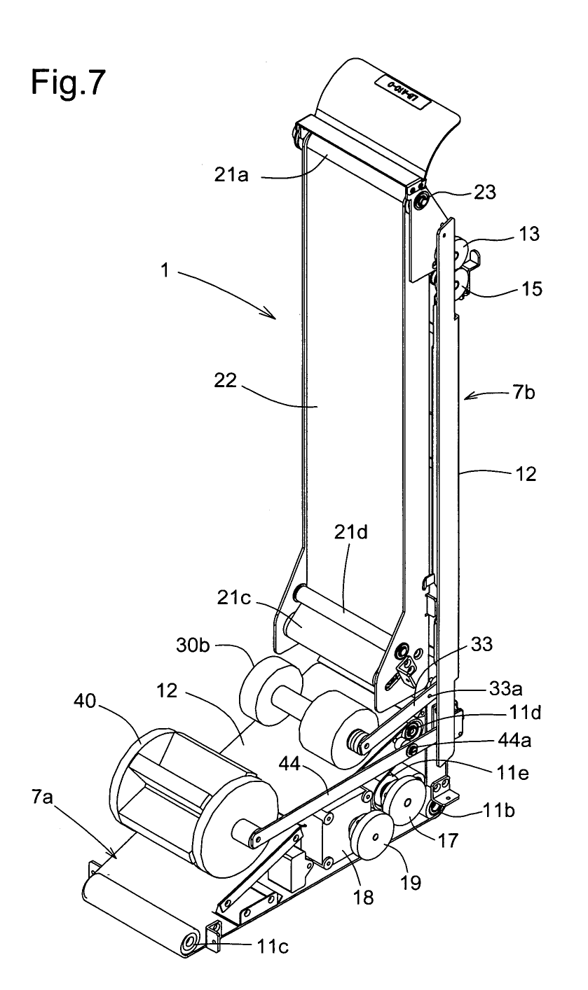

Although the roller member 9 has a construction comprising the press portion 31 and the escape portion 32, it may be constituted a shown in FIGS. 7 and 8.

That is, in FIGS. 7 and 8, a roller member 40 is formed with guide portions 42 of disc-like shape on both end portions of a rotation shaft 41. Between the guide portions 42, five fin portions 43 protrude from the outer surface of the rotation shaft 41 with a constant pitch. The fin portions 43 are so constructed that the medicine package 100 can be sandwiched between at least one of them and the first belt conveyor 7. The roller member 40 is rotatably attached on one end of an arm 44 in the same manner as the above roller member 9. The arm 44 is supported on the frame 6 pivotably around a support shaft 44a. In the embodiment shown in FIG. 8, the guide portions 42 are made of rubber and the fin portions 43 are made of sponge.

According to the roller member 40 having above construction, when the first belt conveyor 7 is driven, the medicine package 100 is conveyed in a state that the medicine package 100 is sandwiched between the flat belt 12 and the at least any one of the fin portions 43 of the roller member 40. The guide portions 42 come into contact with the flat belt 12, preventing unnecessary deformation of the fin portions 43 in a state that the fin portions 43 does not interfere with the bulge portion of the medicine package 100. In the case that the bulge portion as described above is caused while conveying the medicine package 100, the fin portions 43 become elastic deformed, which never prevent the medicine package 100 from being conveyed. If the bulge of the medicine package 100 is caused by erection of the capsule, the fin portions 43 exert a force on the capsule so that the capsule can lay down, facilitating to convey and fold the medicine package 100 thereafter.

In the aforementioned embodiment, the roller members 9, 40 are constituted so as to pivot via the arms 33, 44, though it is also possible to make the arms 33, 44 fixed types.

Although the present invention has been fully described by way of the examples with reference to the accompanying drawing, it is to be noted that various changes and modifications will be apparent to those skilled in the art. Therefore, unless such changes and modifications otherwise depart from the spirit and scope of the present invention, they should be construed as being included therein.

1. A medicine package conveying apparatus, comprising:
a conveyor for conveying a medicine package with a plurality of bags in which medicine is packaged; and
a roller member made of elastic material, the roller member comprising press portions of cylindrical shape which rotate and press the both side edges of the medicine package on the conveyor and an escape portion which is positioned between the press portions and is smaller in a diameter than the press portions.

2. The apparatus as in claim 1, wherein the escape portion is formed so as not to interfere with the medicine package to be conveyed.

3. The apparatus as in claim 1, wherein the roller member is possible to pivot so that the roller member is released from the conveyor when the press portions are pushed up by a force of more than a standard value.

4. A medicine package conveying apparatus, comprising:
a conveyor for conveying a medicine package with a plurality of bags in which medicine is packaged; and
a roller member comprising a plurality of fin portions having an elasticity, the plurality of fin portions radially extending from a rotation shaft of the roller member so that at least one of the plurality of fin portions presses the medicine package on the conveyor.

5. The apparatus as in claim 4, wherein the roller member further comprising guide portions of cylindrical shape, the guide portions being positioned both sides of the rotation shaft and coming into contact with the conveyor to prevent the fin portion from deforming.

6. The apparatus as in claim 4, wherein the plurality of fin portions are positioned with such a pitch that when a capsule as the medicine is contained in the medicine package in a state standing in a direction of thickness of the medicine package, the capsule can be laid down.
